(19) United States
(12) Patent Application Publication
(10) Pub. No.: US 2014/0254477 A1
(43) Pub. Date: Sep. 11, 2014

(54) METHOD FOR ADDING A DEVICE TO A WIRELESS NETWORK

(71) Applicant: LUTRON ELECTRONICS CO., INC., Coopersburg, PA (US)

(72) Inventor: William Bryce Fricke, Bethlehem, PA (US)

(73) Assignee: LUTRON ELECTRONICS CO., INC., Coopersburg, PA (US)

(21) Appl. No.: 13/793,143

(22) Filed: Mar. 11, 2013

(51) Int. Cl. H04W 12/08

(52) U.S. Cl. CPC H04W 12/08
USPC 370/328

(57) ABSTRACT

Load control devices may form an energy control network for the purpose of controlling one or more electrical and/or mechanical loads related to energy control in residential and/or commercial environments. The various load control devices of the energy control network may communicate with one another via a wireless communication network. Access information for communicating with/on a wireless communication network often takes the form of character-based information, such as a service set identifier (SSID), a type of network security, and/or a security key. The load control devices may have user interfaces that may not be well suited via which to enter the access information for a wireless communication network. Techniques and devices are described to provide network access information wirelessly in the form of data packets of modulated lengths to load control devices that may decode the access information from the modulated lengths to join the wireless communication network.

### BACKGROUND

In residential or commercial environments, a number of devices, such as lighting and heating control devices, or the like, may be used to control energy consumption. Such devices may communicate with one another via a wired or wireless network, such as a WiFi protocol based wireless network, for example. Devices such as a dimmer switch, a plug-in load control device (PID), a temperature control device, a contact-closure output (CCO) pack, a remote control device, an occupancy sensor, a temperature sensor, a digital ballast controller, a motorized window treatment, a battery-powered remote control, and/or a daylight sensor, among other devices, may be part of a WiFi communication network. Such networks may be referred to as energy control networks. Examples of additional devices that may be part of such energy control networks are described in greater detail in commonly-assigned U.S. patent application Ser. No. 13/234,758, filed Sep. 16, 2011, and entitled LOAD CONTROL SYSTEM HAVING AN ENERGY SAVINGS MODE, the entire disclosure of which is hereby incorporated by reference.

FIG. 1A illustrates an example of load control system (or an energy control network). As shown in FIG. 1A, a user 112 may control a lighting control device, such as a dimmer switch 106 for controlling a lighting load 132, and/or motorized window treatments 110 in room 130 using a remote control device 104 (e.g., a LUTRON® PICO® wireless remote control device). In addition, the dimmer switch 106 and/or the motorized window treatments 110 may be controlled automatically in response to an occupancy sensor 134. Also, the user 112 may use a temperature control device 102 to adjust a heating, air-conditioning, and ventilation (HVAC) system to control a temperature in the room 130. Similar systems have been developed to incorporate the use of other wireless devices (e.g., tablets and/or cellular phones) as remote load controls.

Devices, for example load control devices, that may be part of an energy control network have user interfaces that are particular to the intended use of those devices. For example, FIG. 1B depicts an exemplary dimmer switch 106 that has a rocker switch with which a user can either raise or lower an intensity of a lighting load in communication with the dimmer switch 106. FIG. 2 depicts an exemplary remote control device 104 having a user interface that includes one or more buttons that can be used for functions like sending a “raise” and/or “lower” command to a shade control device, or perhaps an “on” or “off” or assume a predetermined lighting “scene” command) to one or more load control devices. FIG. 3 depicts an exemplary temperature control device 102 has a user interface that includes an “up” arrow and a “down” arrow to facilitate the adjustment of a temperature set-point for the area that the temperature control device monitors and controls.

Typically, network access information takes the form of character-based (e.g. alpha-numeric) information. FIG. 4 illustrates exemplary network access information (e.g. credentials) for a WiFi network that may include a service set identifier (SSID) that may uniquely identify a wireless local area network (LAN). The network credentials of FIG. 4 may also include a Type of security protocol (e.g. WPA, WPA2, WEP, etc.). Also, the network credentials of FIG. 4 may also include a Key for satisfying the security protocol requirements corresponding to the security protocol identified in the Type field. For example, a Key may be a 40 bit or 104 bit encryption key that is entered on devices that join/access a wireless communication network protected by a security protocol that may utilize such keys.

The user interfaces of the devices that may be part of an energy control network are not well suited for entry of the kind of network access information that such devices may require to join a wireless communication network, such as a WiFi communication network. And wireless communication networks communicate in encrypted form making the interpretation of information communicated on such networks practically impossible without having network access information.

### SUMMARY

Contemplated devices and techniques offer user-friendly solutions to add devices to a wireless communication network. For example, unlike presently known solutions, the devices and techniques described herein do not require an input device to discontinue communication with the wireless communication network, even temporarily, so that the input device may provide access information (e.g., passwords, system identifiers, etc.) for the wireless communication network to another device with a less optimal user interface. Also, the devices described herein that have less optimal user interfaces and may be configured to receive access information for a wireless communication network, such as wall-mounted dimmer switches, load control devices, gateway devices, remote control devices, and sensor devices, for example, do not require additional hardware to receive the access information. For example, a dimmer switch configured as described herein may use one WiFi communication module to both communicate with a local WiFi communication network and also receive access information for the WiFi communication network.

A contemplated device equipped with a character-based user interface and that is capable of wireless transmission, such as a “smart” phone or a laptop personal computer, may be configured to modulate the length of one or more data packet lengths to represent access information for a wireless communication network, for example a WiFi communication local area network (LAN). A user, perhaps after recently installing or replacing a load control device that is also capable of wireless communication—but lacking a character-based user interface (e.g. alpha-numeric or similarly flexible user interface)—may supply the access information for a wireless communication network (e.g. SSID, Type, Key, etc.) to the character-based user interface equipped wireless device. The character-based user interface equipped wireless device may generate and/or transmit the data packets of modulated lengths to a predetermined address that has been set aside to communicate such access information (e.g. a null address). The character-based user interface equipped device may generate and/or transmit the data packets of modulated length while in a particular mode of operation. Otherwise, while in a different mode of operation (perhaps a “normal” mode of operation), the character-based user interface equipped device may wirelessly communicate data packets via a predetermined protocol (e.g. a WiFi protocol), such as the kind of data packets that may be wirelessly transmitted in the normal course of the device's operation.

The character-based user interface equipped device may include a specific application programming interface (API), which may be activated by the user and which may be configured to receive the user-input network access information. The API (perhaps via a touch screen interface or hard-key interface, or both) may also be used to initiate the generation and/or transmission of the data packets of modulated lengths to the predetermined address of the wireless communication network.

The character-based user interface equipped device may be further configured to continue to transmit the data packets of modulated lengths for a predetermined period of time and/or until such time as at least one signal has been received from a load control device that has recently used the network access information communicated by the data packets of modulated lengths to access (or join) the wireless communication network.

A load control device that may be capable of wireless communication and equipped with a user interface to control or interact with other devices of an energy control network, such as another load control device (e.g. a dimmer switch or a temperature control device), may be configured to listen for wireless signal transmissions directed to a predetermined address that has been set aside (e.g. a null address) for communication of access information for a wireless communication network, for example a WiFi communication local area network (LAN). The load control device may be configured to receive wireless signals directed to the null address and to determine (e.g. decode) the access information based on the data packets of modulated lengths contained in, or represented by, the wireless signals. The load control device may access (e.g. join) the wireless communication network using the access information conveyed by the lengths of the data packets.

The load control device may monitor the predetermined address (e.g. null address) to listen for and/or receive the wireless signals containing the data packets of modulated lengths after being placed into a mode of operation, such as an associate mode.

The load control device may transmit a confirmation signal upon successfully accessing (e.g. joining) the wireless communication network using the access information determined (e.g. decoded) from the data packets of modulated lengths.

### BRIEF DESCRIPTION OF THE DRAWINGS

FIG. 1A depicts an example load control system environment.

FIG. 1B depicts an example dimmer switch that is capable of wireless communication.

FIG. 2 depicts an example remote control device that is capable of wireless communication.

FIG. 3 depicts an example temperature control device that is capable of wireless communication.

FIG. 4 depicts example network access information for a wireless communication network.

FIG. 5 depicts an example wireless device with a character-based interface.

FIG. 6 is an example schematic of the wireless device depicted in FIG. 5.

FIG. 7 illustrates an exemplary communication scheme for placing one or more devices into communication with a wireless communication network.

FIG. 8 is an example schematic of one of the devices placed into wireless communication with the wireless communication network illustrated in FIG. 7.

FIG. 9 illustrates wireless transmission/reception of length modulated data packets.

FIG. 10 illustrates an example decoding of network access information from length modulated data packets.

FIG. 11 is a flow chart of an example technique of transmitting network access information via length modulated data packets.

FIG. 12 is a flow chart of an example technique for accessing a wireless communication network using network access information determined from length modulated data packets.

FIG. 13 is a flow chart of an example technique for providing a wireless communication device with a configuration to generate and/or transmit data packets of modulated lengths that convey access information of a wireless communication network.

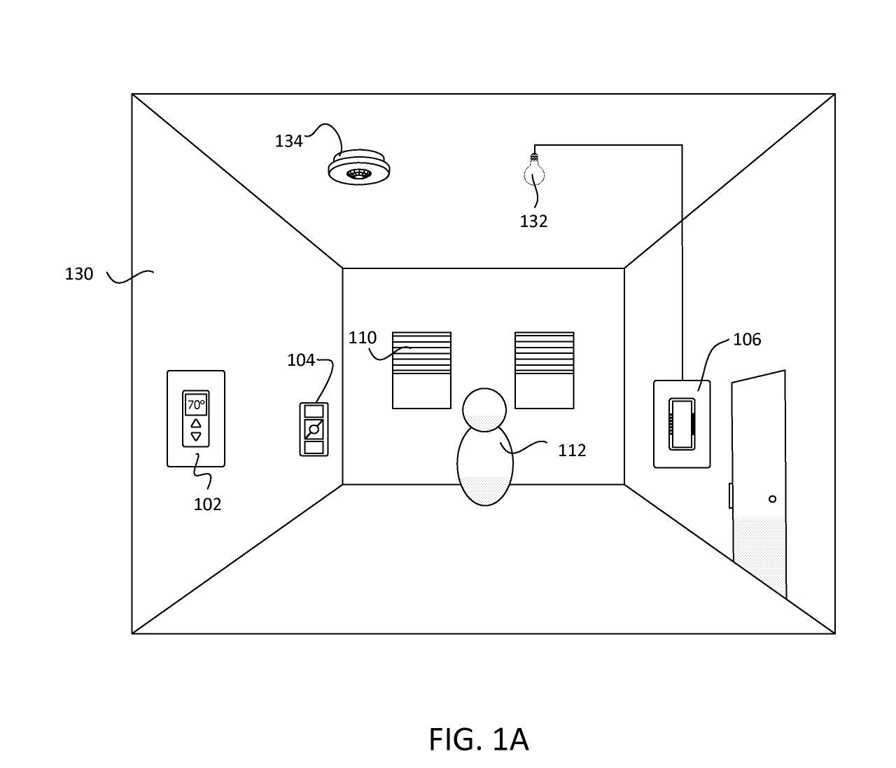

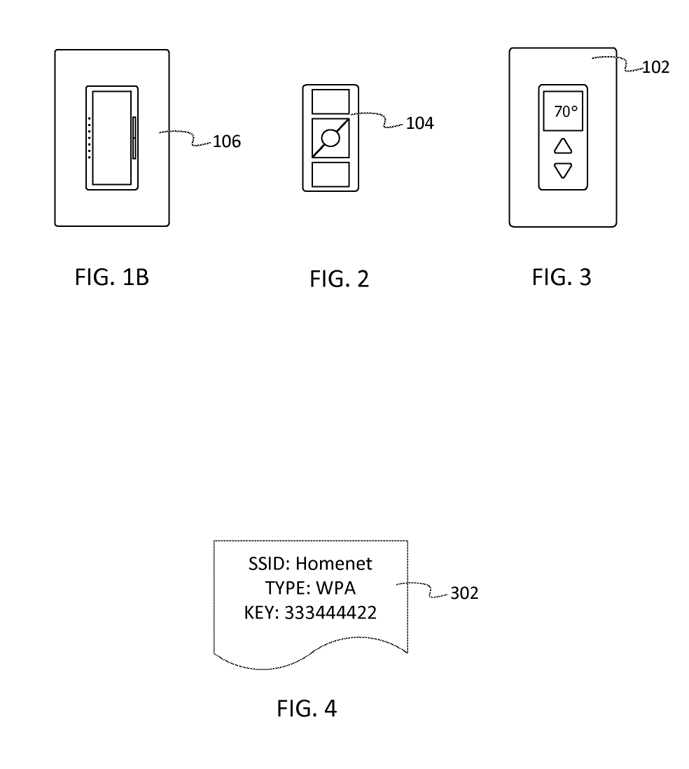

### DETAILED DESCRIPTION

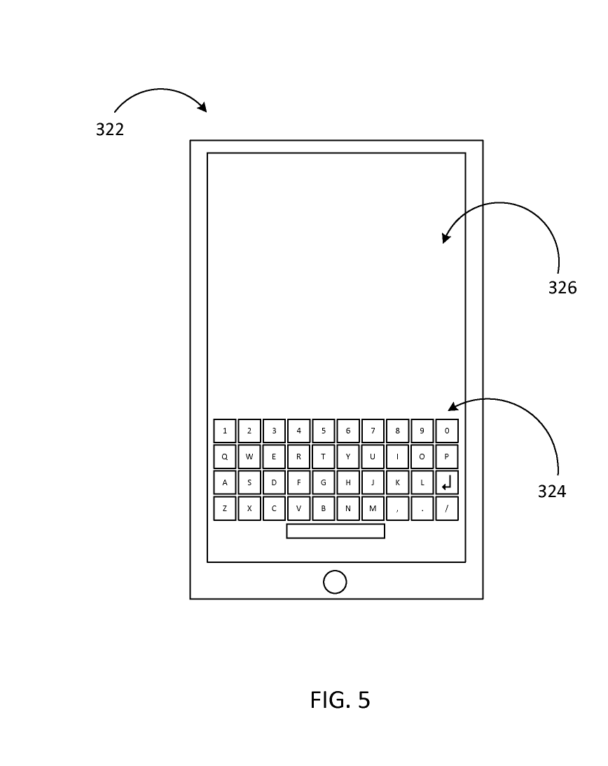

FIG. 5 depicts an example of a wireless device 322 (e.g. a “smart” cellular phone) that is configurable to communicate with the Internet and also with wireless networks, such as a WiFi communication network. The wireless device 322 includes a character-based user interface that may include an alpha-numeric keyboard 324 (e.g. a “QWERTY” keyboard) and/or a touch-screen interface 326. The alpha-numeric keyboard 324 may be either a hard-key keyboard or a “virtual” keyboard. The alpha-numeric keyboard 324 may be well suited for entering alpha-numeric information such as wireless communication network access information. Indeed, such keyboards, also common on personal computers (e.g. laptop computers), are more suitable interfaces (for example, as compared to the user interfaces of the temperature control device 102, the remote control device 104, and/or the dimmer switch 106) on which to enter the wireless network access information illustrated in FIG. 4. The wireless device 322 may also communicate wirelessly with one or more other devices that may be part of a WiFi communication network to which the wireless device 322 has accessed/joined. And wireless device 322 may be capable of broadcasting wireless signals to other devices that are capable of wireless communication where those other such devices may not be (or may not yet be) part of the same wireless communication network to which the wireless device 322 belongs, or may not be part of any wireless communication network.

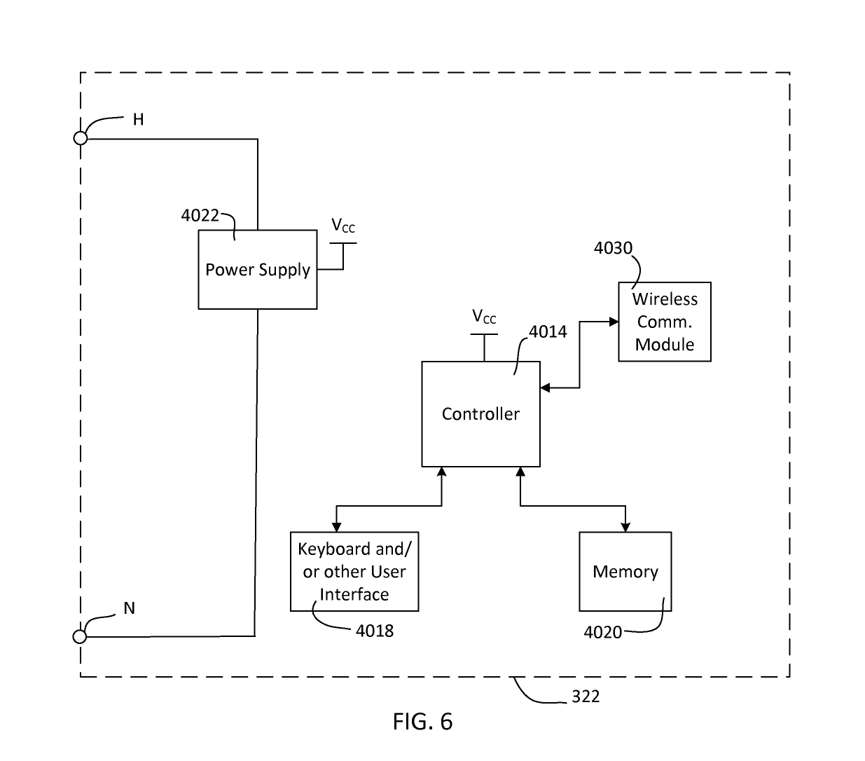

FIG. 6 is a simplified block diagram of the wireless control device 322. The wireless device may include a controller 4014. The controller 4014 may comprise a microcontroller, a programmable logic device (PLD), a processor, a microprocessor, an application specific integrated circuit (ASIC), a field-programmable gate array (FPGA), and/or any suitable processing device or control circuit. The controller 4014 may be configured to implement one or more of the contemplated techniques described herein to communicate access information for a wireless communication network via data packets of modulated lengths.

The controller 4014 may also be coupled to a memory 4020 that may be used for storage of, among other things, access information for a wireless communication network, such as the SSID, security type, and/or key. The memory 4020 may also store programming instructions for communicating via a wireless communication link, or the like. The memory 4020 may be implemented as an external integrated circuit (IC) or as an internal circuit of the controller 4014. The wireless device 322 may further comprise a power supply 4022 that may generate a direct-current (DC) voltage V_{CC} for powering the controller 4014, the memory 4020, a wireless communication module 4030, a user interface input-output module 4018, and other elements of the wireless device 322 shown and not shown. The power supply 4022 may be coupled to an alternating-current (AC) power source (not shown) via hot and neutral terminals H, N. Alternatively, the wireless device 322 could comprise a battery for providing a battery voltage for powering the controller 4014, the memory 4020, a wireless communication module 4030, a user interface input-output module 4018, and other elements of the wireless device, such that the wireless control device 322 does not require the hot and neutral terminals H, N.

The wireless device 322 may further include the wireless communication module 4030 for transmitting and receiving radio frequency (RF) signals to and from the wireless device 322. For example, the wireless communication module 430 may be configured to communicate via a Wi-Fi communication link, a Wi-MAX communication link, a Clear Connect™ communication link, and/or a Bluetooth® communication link. When the wireless communication module 4030 comprises a Wi-Fi module, the controller 4014 may be operable to communicate via digital messages in Wi-Fi packets (e.g., Internet Protocol packets received via the Wi-Fi signals). The wireless communication module 4030 may include one or more RF transceivers and at least one antenna. The one or more RF transceivers may include one or more RF transmitters (e.g. transmitter circuits) and/or one or more RF receivers (e.g. receiver circuits). The controller 4014 may transmit messages from the wireless device 322 via digital messages transmitted via the RF signals. For example, the controller 4014 may be used to transmit digital messages via wireless communication.

The wireless device 322 may also include a user-interface input-output module 4018 for operating a character-based keyboard (hard-key or virtual) and/or another user/interface, such as a touch-screen interface. The controller 4014 may communicate with the user interface input-output module 4018 to receive user-input information (e.g. the access information for the wireless communication network). The controller 4013 may also communicate with the user-interface input-output module 4018 to allow the user to interact with and to control various functions that the controller may be configured to perform, such as but not limited to one or more of the contemplated techniques described herein to communicate access information for a wireless communication network via data packets of modulated lengths.

Existing solutions to provide devices with access information for wireless communication networks require a device providing such access information to transmit the network access information via a predetermined unencrypted beacon. Transmitting the predetermined unencrypted beacon requires the providing device be removed from its primary network, at least for the time required to generate and transmit the predetermined unencrypted beacon.

It would be useful if a character-based keyboard (e.g. “QWERTY” keyboard) equipped and wireless communication capable device, such as wireless device 322 or the like, could be used to provide wireless communication network access information in a relatively user-friendly manner to control devices such as the temperature control device 102, the remote control device 104, and/or the dimmer switch 106 when such devices are not part of a WiFi network and lack the requisite access information (e.g. when such devices are newly installed and/or are replaced).

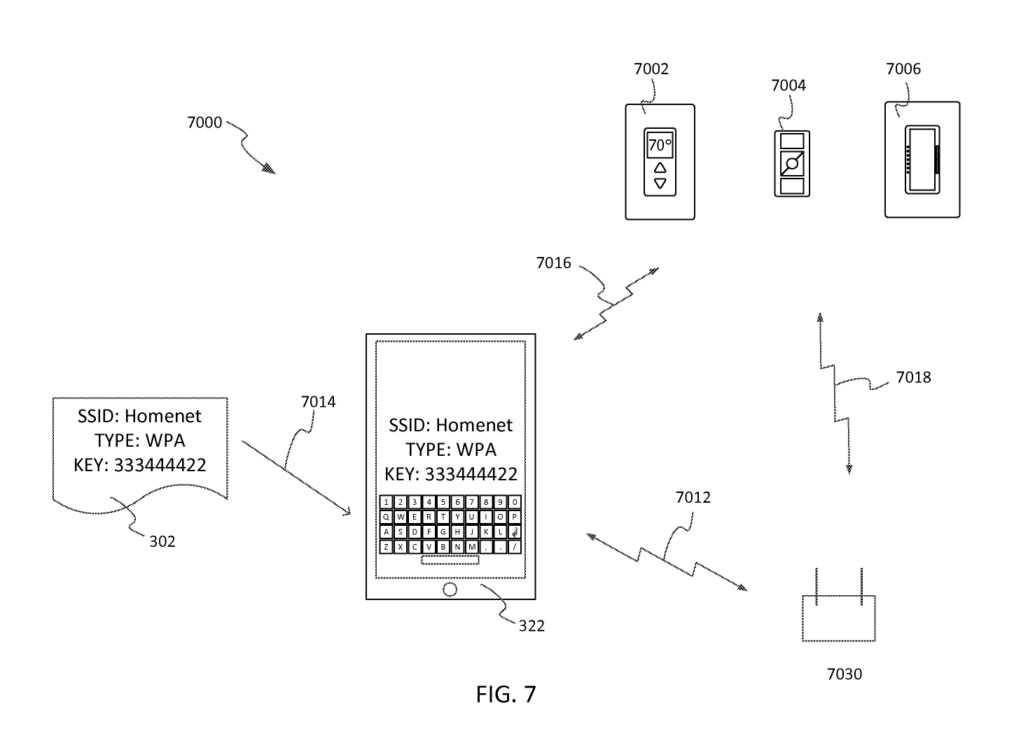

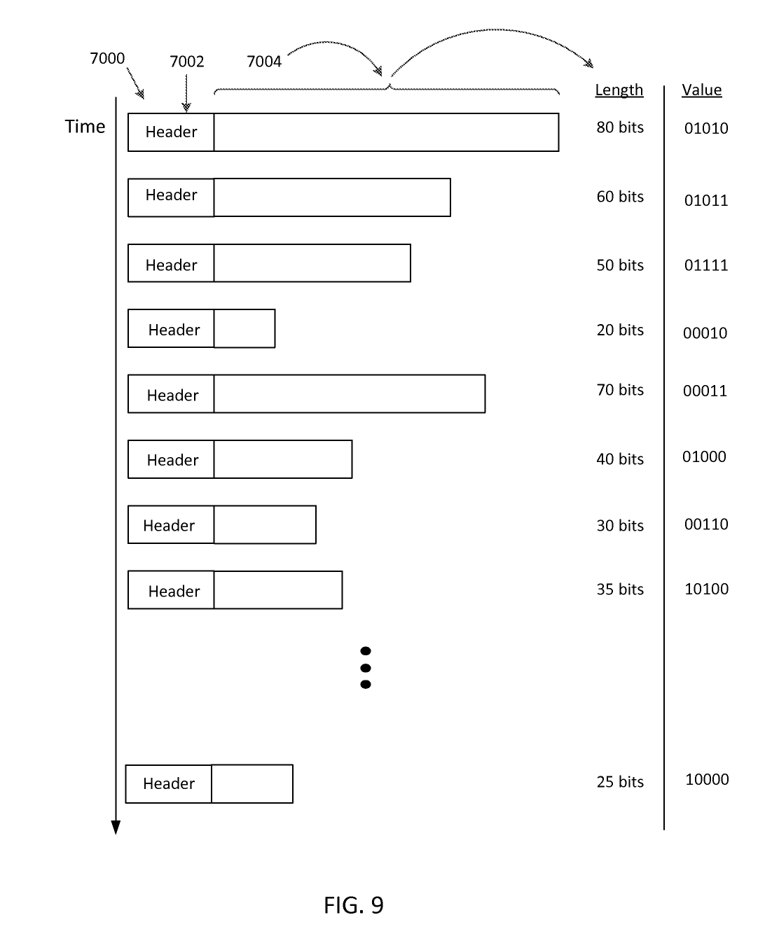

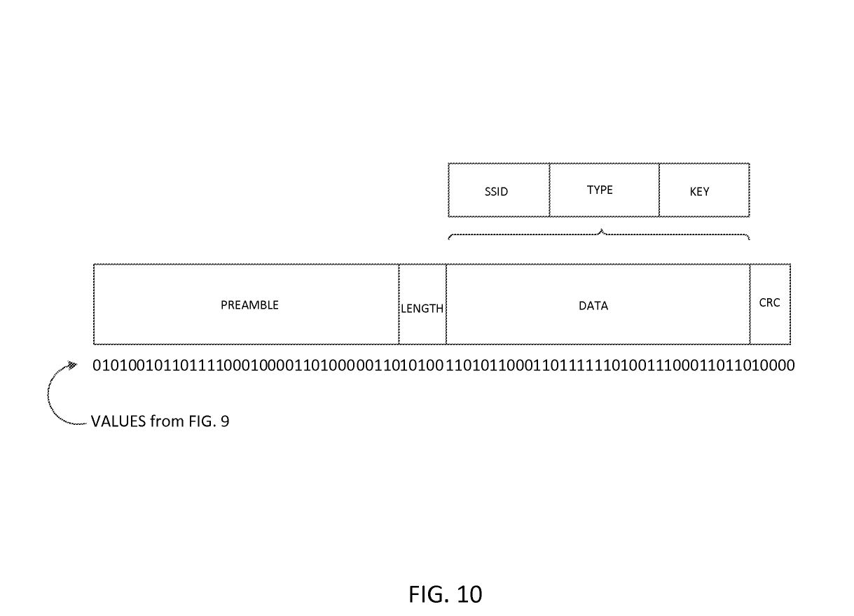

FIG. 7 illustrates an exemplary wireless communication network environment 7000 in which, at 7012, a wireless device 322 may be placed into communication with a wireless communication network router 7030. At 7014, a user may input access information 302 for the wireless communication network into the wireless device 322 (e.g., using the character-based keyboard). For example, the user may input the same information the wireless device 322 used to access or join the wireless communication network. The wireless device 322 (via techniques to be described in greater detail with regard to FIGS. 9 and 10) may modulate the respective length of one or more data packets in a manner such that the respective modulated lengths of the one or more data packets may represent or may correspond to the network access information 302 entered by the user. At 7016, the wireless device 322 may wirelessly transmit signals that may include (or may represent) the data packets of modulated lengths in a transmission that may be directed to a predetermined address of the wireless communication network. One or more of the load control devices 7002, 7004, and/or 7006, perhaps after being placed into one mode of one or more configurable modes (e.g. may be placed into an “associate” mode after initial installation or replacement), may monitor wireless transmissions directed to the predetermined address and receive the signals that include the data packets of modulated lengths. One or more of the load control devices 7002, 7004, and/or 7006 may decode the network access information from the data packets of modulated lengths and, at 7018, may use the network access information to access (or “join”) the wireless communication network (e.g. communicate with the router 7030 and/or other devices that have accessed the wireless communication network).

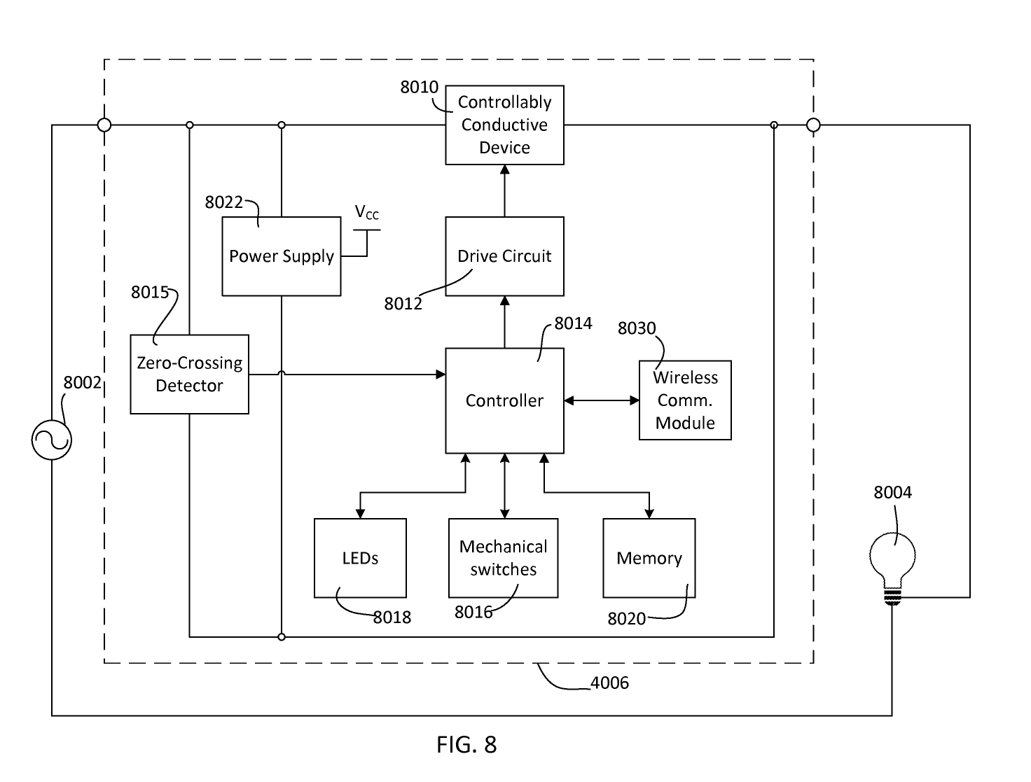

FIG. 8 is a simplified block diagram of the dimmer switch 7006 (as an example load control device capable of receiving and decoding access information for a wireless communication network conveyed by data packets of modulated lengths). The dimmer switch 7006 may include a controllably conductive device 8010 coupled in series electrical connection between an AC power source 8002 and a lighting load 8004 for control of the power delivered to the lighting load. The controllably conductive device 8010 may comprise a relay or other switching device, or any suitable type of bidirectional semiconductor switch, such as, for example, a triac, a field-effect transistor (FET) in a rectifier bridge, or two FETs in anti-series connection. The controllably conductive device 8010 may include a control input coupled to a drive circuit 8012.

The dimmer switch 7006 may further include a controller 8014 coupled to the drive circuit 8012 for rendering the controllably conductive device 8010 conductive or non-conductive to thus control the power delivered to the lighting load 8004. The controller 8014 may include a microcontroller, a programmable logic device (PLD), a microprocessor, an application specific integrated circuit (ASIC), a field-programmable gate array (FPGA), or any suitable processing device or control circuit. A zero-crossing detector 8015 may determine the zero-crossings of the AC line voltage from the AC power supply 8002. A zero-crossing may be the time at which the AC supply voltage transitions from positive to negative polarity, or from negative to positive polarity, at the beginning of each half-cycle. The controller 8014 may receive the zero-crossing information from the zero-crossing detector 8015 and may provide the control inputs to the drive circuit 8012 that may render the controllably conductive device 8010 conductive and non-conductive at predetermined times relative to the zero-crossing points of the AC waveform.

The controller 8014 may receive inputs from mechanical switches 8016 that may be mounted on a printed circuit board (not shown) of the dimmer switch 7006, and may be arranged to be actuated by a toggle actuator (not shown) and an intensity adjustment actuator (not shown). The controller 8014 may also control light-emitting diodes 8018, which may also be mounted on the printed circuit board. The light emitting diodes 8018 may be arranged to illuminate the status indicators (not shown) on the front surface of the dimmer switch 7006, for example, through a light pipe structure (not shown). The controller 8014 may also be coupled to a memory 8020 for storage of unique identifiers (e.g., the MAC address and the IP address) of the dimmer switch 7006, the SSID, the security type, and/or the security key of the wireless communication network, instructions for controlling the lighting load 8004, programming instructions for communicating via a wireless communication link, or the like. The memory 8020 may be implemented as an external integrated circuit (IC) or as an internal circuit of the controller 8014. A power supply 8022 may generate a direct-current (DC) voltage V_{CC} for powering the controller 8014, the memory 8020, and other low-voltage circuitry of the dimmer switch 7006.

The dimmer switch 7006 may further include a wireless communication module 8030 for transmitting and receiving the RF signals to and from the wireless device 322 and/or the wireless router 7030. For example, the wireless communication module 8030 may be configured to communicate via a Wi-Fi communication link, a Wi-MAX communication link, a Clear Connect™ communication link, and/or a Bluetooth® communication link. When the wireless communication module 8030 comprises a Wi-Fi module, the controller 8014 may be operable to control the lighting load 8004 in response to received digital messages in Wi-Fi packets (e.g., Internet Protocol packets received via the Wi-Fi signals). The wireless communication module 8030 may comprise an RF transceiver and an antenna. The one or more RF transceivers may include one or more RF transmitters (e.g. transmitter circuits) and/or one or more RF receivers (e.g. receiver circuits).

Examples of antennas for wall-mounted dimmer switches are described in greater detail in U.S. Pat. No. 5,982,103, issued Nov. 9, 1999, and U.S. Pat. No. 7,362,285, issued Apr. 22, 2008, both entitled COMPACT RADIO FREQUENCY TRANSMITTING AND RECEIVING ANTENNA AND CONTROL DEVICE EMPLOYING SAME, the entire disclosures of which are hereby incorporated by reference.

The controller 8014 may also transmit and receive messages to the wireless device 322 via digital messages transmitted via the RF signals. For example, the controller 8014 of the dimmer switch 7006 may be used to transmit digital messages to the wireless device 322 via wireless communication. The digital messages may include alerts and/or feedback and status information regarding the lighting load 8004. The digital messages may also include error messages or indications as to whether the dimmer switch 7006 may be able to communicate via a wireless communication link or RF signal, for example.

FIG. 9 illustrates an example transmission and/or reception of data packets of modulated lengths. One or more of the data packets of modulated lengths 7000 may include a header 7002 and a payload 7004. The header 7002 may be the same or similar for each of the data packets of modulated lengths 7000. The header 7002 may include an address of a wireless communication network to which the data packets of modulated lengths 7000 are directed (e.g. an address of an intended recipient on the wireless communication network that may be set aside for purposes of communicating access information for the wireless communication network). The length of the payload 7004 may be respectively varied (or modulated) for each of the data packets of modulated lengths 7000, such that the varied (or modulated) lengths of the payload 7004 may convey at least a part of access information for the wireless communication network. The payload 7004 may be encrypted or unencrypted. In the example of FIG. 7, a number of data packets of modulated lengths 7000 are shown, each with different modulated length payloads 7004. In other examples not shown, some of the modulated lengths of the payloads 7004 may be the same or may be repeated more than once, based on the access information to be conveyed.

The modulated lengths of the payload 7004 illustrated in FIG. 9 may be measured at the time of generation, transmission, and/or reception in units of bits (e.g. 80 bits, 70 bits, etc.) or other length units not shown, but known to those skilled in the art. Also, devices that generate, transmit, or receive wireless signals that include the data packets of modulated lengths 7000 may be configured to assign a value to the measured length of the payload 7004 of the respective data packets of modulated lengths 7000. For example, a 5-bit word binary value of 01111 may be assigned to a measured payload 7004 length of 50 bits. Also by way of example, a 5-bit binary work value of 01011 may be assigned to a measured payload 7004 length of 60 bits. Other assigned values and/or values of different lengths and/or bases (e.g. decimal, hexadecimal, octal, etc.) not shown, but known to those skilled in the art may also be used. FIG. 9 illustrates an example of measured lengths in bits of payloads 7004 of data packets of modulated lengths 7000 along with correspondingly assigned 5-bit binary word values for the measured bit lengths. The length of a data packet may be referred to as a symbol, for example. By way of further example, if a data packet may have a minimum length M, and a maximum length N, then in some configurations the number of bits encoded per symbol may be provided by the calculation of log₂ (N-M).

FIG. 10 illustrates an example decoding (e.g. interpretation and/or translation) that a device configured to generate, transmit, and/or receive the data packets of modulated lengths 7000 may perform. By way of example, in one or more decoding configurations, a 5-bit binary word that may have a 0 in the most significant bit may indicate that the 5-bit binary word is indicative of a preamble (e.g. a leading 0 may be reserved for preamble words). Also, in some decoding configurations, seven 5-bit binary words (e.g., 35 bits) may be used to convey preamble information, where a first preamble word may indicate a parameter of the access information (e.g. an SSID, a type, a key, etc.), the second through sixth preamble words may convey a character of the parameter (e.g. a 1^{st}, 2^{nd}, 19^{th}, 64^{th}, etc.), and the seventh preamble word may convey how the character of the parameter may be interpreted (e.g. numerically, ASCII, etc.). For example, a 5-bit binary word preamble sequence may convey that information for a 39^{th} character of the key parameter (to follow) may be interpreted in an ASCII format. In some decoding configurations, a first preamble 5-bit binary word may indicate a parameter of the access information and a last preamble 5-bit binary word may convey how the character of the parameter may be interpreted—where any number of intervening 5-bit binary preamble words that fall between the first and the last preamble 5-bit binary words may convey a character of the parameter.

Continuing to refer to the decoding example illustrated in FIG. 10, following the preamble sequence (which has seven 5-bit binary words) is a length, which may be a 5-bit binary word leading with a 1 in the most signification bit position. The length may convey the number of 5-bit binary words (to follow) that may be used to convey the information indicated by the preamble sequence. For example, the length (having one 5-bit binary word) may convey that the information (i.e., the access information for the network) that follows the length may have seven 5-bit binary words. For example, the seven 5-bit binary words may be used to convey the ASCII value for a lower case “a”, among other examples. In some decoding configurations, a device configured to decode the data packets of modulated lengths 7000 may be configured to initiate access of the wireless communication network using the access information conveyed by the modulated lengths after a level of repetition is detected in the wirelessly conveyed information. For example, a decoding device may initiate access of the wireless communication network after it interprets the same characters of the access information more than once.

As illustrated in FIG. 10, in some decoding configurations, a cyclic redundancy check (CRC) (or some other error-detecting code known to those of skill in the art) may be added to detect errors in the data conveyed by data packets of modulated lengths 7000. A CRC 5-bit binary word may be conveyed following the sequence of 5-bit binary words that may be used to convey the information indicated by the preamble sequence. For example, where the length (having one 5-bit binary word) may convey that the information that follows the length may have seven 5-bit binary words, the next 5-bit binary word after the seven 5-bit binary words (e.g. an eighth 5-bit binary word) may be interpreted as a CRC.

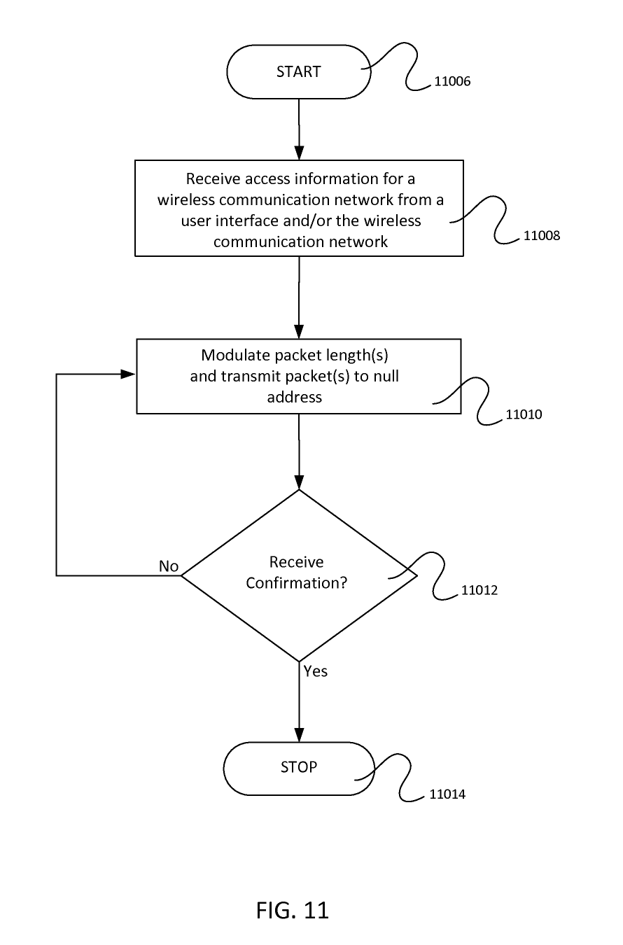

FIG. 11 is a flowchart of an example technique for generating and transmitting data packets of modulated lengths to convey access information for a wireless communication network to one or more devices, such as load control devices. At 11006, a device, such as a laptop computer or a handheld wireless device (e.g. smart phone), may be configured to communicate on a wireless communication network, perhaps at some time before the installation or replacement of a load control device. At 11008, the device may receive at least a part of the access information for the wireless communication network (e.g. SSID, type, and/or key value) from a user via a character-based user interface (e.g. an alpha-numeric keyboard) and/or from the wireless communication network itself. For example, the device (or perhaps a processor of the device) may be configured to receive the at least part of the access information of the wireless communication network via the character-based user interface, such as a hard-key alpha-numeric keyboard or a virtual alpha-numeric keyboard. By way of further example, the alpha-numeric keyboard may be a “QWERTY” hard-key keyboard or a virtual “QWERTY” keyboard.

At 11010, the device may modulate the length of one or more packets such that the modulated lengths may convey the access information for the wireless communication network. The device may also transmit the data packets of modulated lengths via a wireless signal that may be directed to a predetermined address of the wireless communication network (e.g. a null address) that may be set aside for conveying network access information. For example, a wireless transmitter or transceiver in the device may be configured to transmit the data packets of modulated lengths, via the wireless signal, where the modulated lengths may convey at least a part of the access information of the wireless communication network. Also by way of example, a processor in the device may be configured to respectively modulate a length of one or more of the data packets to generate the data packets of modulated lengths. And the device processor may be configured to initiate the transmission of the data packets of modulated lengths via the wireless transceiver or transmitter.

The character-based user interface equipped device may generate and/or transmit the data packets of modulated length while in a particular mode of operation. Otherwise, while in a different mode of operation (perhaps a “normal” mode of operation), the character-based user interface equipped device may wirelessly communicate data packets via a predetermined protocol (e.g. a WiFi protocol), such as the kind of data packets that may be wirelessly transmitted in the normal course of the device's operation.

The device's character-based user interface may also be configured such that the generation of the data packets of modulated lengths and/or the transmission of the data packets of modulated lengths can be initiated via the user interface. By way of further example, the character-based user interface may also include a touch-screen interface and/or a combination touch-screen and hard-key interface.

The device may transmit the wireless signal representing the data packets of modulated lengths to the predetermined address for a predetermined amount of time, until the device receives a confirmation of some kind, and/or until the device is requested to stop by user. In some configurations, the device (or perhaps the device's wireless transceiver or receiver) may be configured to receive an indication from the wireless communication network, where the indication may indicate that at least one other device (e.g. a load control device) may have accessed the wireless communication network. The device (or perhaps the device's processor) may be configured to determine if the indication was received after the transmission of the data packets of modulated lengths was initiated. Also, the device (or perhaps the device's processor) may be configured to initiate a termination of the transmission of the data packets of modulated lengths upon the determination that the indication was received after the transmission of the data packets of modulated lengths was initiated.

In some configurations, a first device that sent the data packets of modulated lengths (or perhaps the first device's wireless transceiver or receiver) may be configured to receive a wireless signal from a second device (e.g. a load control device). The wireless signal may indicate that the second device may have used the data packets of modulated lengths to access the wireless communication network. The first device (or perhaps the first device's processor) may be configured to determine if the signal was received after the transmission of the data packets of modulated lengths was initiated. Also the first device (or perhaps the first device's processor) may be configured to initiate a termination of the transmission of the data packets of modulated lengths upon the determination that the signal was received after the transmission of the data packets of modulated lengths was initiated.

Continuing to refer to FIG. 11, at 11012, the device may receive a confirmation that one or more other devices, such as load control devices, may have utilized the access information conveyed by the data packets of modulated lengths to access (or “join”) the wireless communication network. At 11014, the device may cease transmitting the wireless signal representing the data packets of modulated lengths, perhaps until such time as a user wishes to reinitiate the transmission to provide newly installed or recently replaced load control devices with network access information.

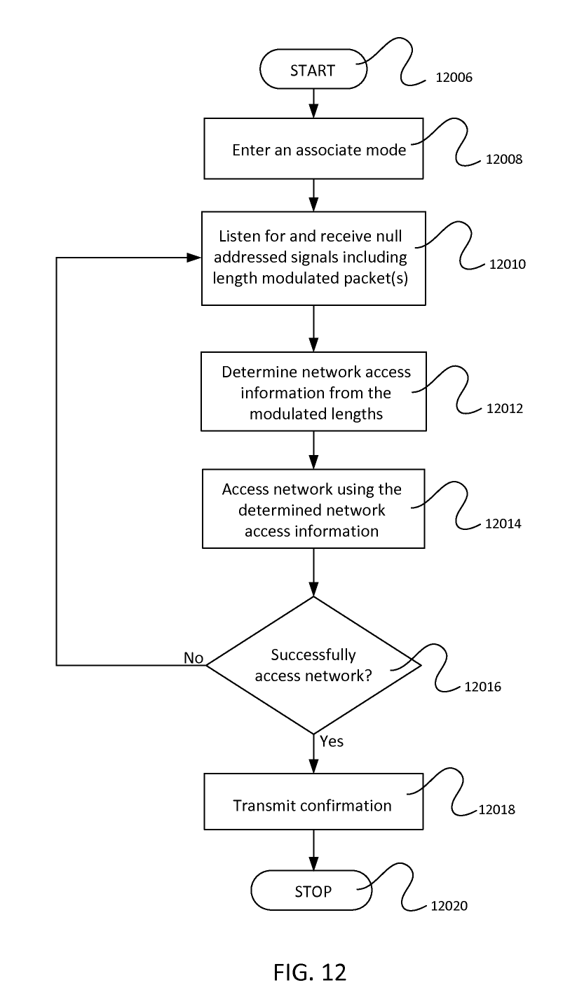

FIG. 12 is a flowchart of an example technique for receiving and/or decoding data packets of modulated lengths that may convey access information for a wireless communication network to one or more devices, such as load control devices. At 12006, perhaps after being newly installed or recently replaced, a device configured to communicate with/on a wireless communication network (e.g. a load control device) may lack the access information for the wireless communication network. At 12008, in some configurations, the device (or perhaps a device processor) may be placed into at least a first mode of operation of one or more modes of operation. For example, the device may include a user interface via which the device (or perhaps the device's processor) may be placed into the first mode, which may be an “associate mode.”

At 12010, the device (or perhaps the device's wireless transceiver or receiver) may be configured to listen for and receive a wireless signal directed to the predetermined address (e.g. a null address of the wireless communication network). In some configurations, the device (or perhaps the device's wireless transceiver or receiver) may be configured to listen for and receive the wireless signal directed to the predetermined address upon receiving an indication from the device's processor that the processor has been placed into the first mode. The wireless signal may include data packets of modulated lengths, where the modulated lengths may convey at least a part of access information of the wireless communication network.

At 12012, the device (or perhaps the device's processor) may be configured to determine the at least a part of the access information for the wireless communication network from the modulated lengths. The data packets of modulated lengths may have respective lengths and the device (or perhaps the device processor) may be further configured to determine the at least a part of the access information for the wireless communication network from the modulated lengths by decoding the respective lengths.

At 12014, the device (or perhaps the device's processor) may be configured to initiate access to the wireless communication network using the at least a part of the access information for the wireless communication network determined from the modulated lengths. At 12016, the device (or perhaps the device's processor) may be configured to determine that access to the wireless communication network has been obtained. At 12018, the device (or perhaps the device's processor) may be configured to send a signal via the device's wireless transceiver or transmitter that may indicate that the device accessed the wireless communication network using the at least a part of the access information for the wireless communication network determined from the modulated lengths. For example, the wireless signal sent to the predetermined address of the wireless communication network that contained (or represented) the data packets of modulated lengths may also include the address of the device that transmitted that wireless signal (e.g. an origin address). The signal indicating that the at least a part of the access information for the wireless communication network was used to access the network may be sent to the origin address.

At 12020, perhaps after accessing the wireless communication network with the access information decoded from the data packets of modulated lengths, the device (or perhaps the device's processor and/or wireless transceiver or receiver) may be configured to stop listening for wireless signals directed to the predetermined address of the wireless communication network. In some configurations, the device (or perhaps the device processor) may be configured to place itself into another mode of operation of the one or more modes of operation (e.g. an “operate mode” or a “configuration mode”) upon accessing the wireless communication network.

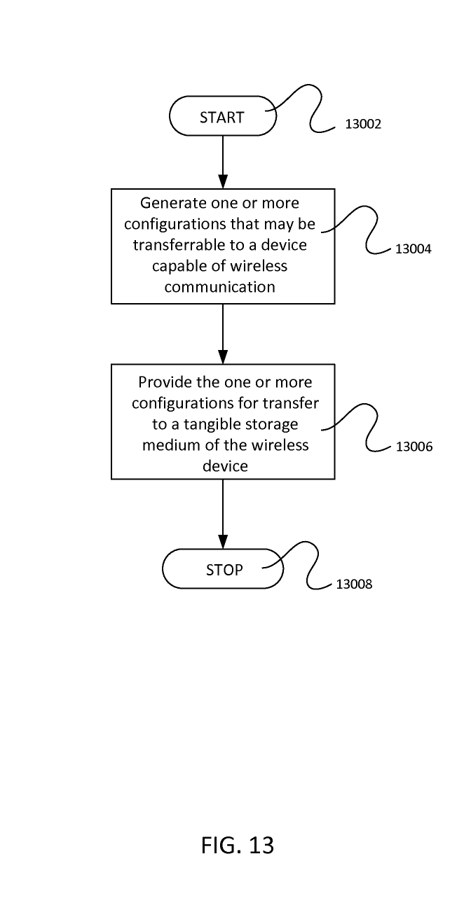

FIG. 13 is a flow chart of an example technique for providing a wireless communication device with at least one configuration of one or more configurations to generate and/or transmit data packets of modulated lengths that may convey access information of a wireless communication network. At 13002, a provider may set out to develop a technique to convey access information for a wireless communication network via the transmission of data packets of modulated lengths, where the technique may be embodied by computer-executable instructions (e.g. a configuration). At 13004, a provider may generate one or more configurations that may be transferrable to a device capable of wireless communication. The device may include a suitable controller, memory, and user interface, among other elements, for executing the configuration (e.g. the wireless device 322). The device may also include a tangible storage medium (e.g. the memory of wireless device 322) capable of storing the configuration upon a transfer to the wireless device. The configuration may include computer-executable instructions for obtaining access information for a wireless communication network.

At 13006, the provider may provide the one or more configurations for transfer to a tangible storage medium of the wireless device. The one or more configurations may include computer-executable instructions. When executed by a processor of the wireless device, the computer-executable instructions may cause the processor to perform one or more of the computer-executable instructions. In an example configuration, the one or more computer-executable instructions may include an instruction to respectively modulate a length of data packets to generate data packets of modulated lengths such that the modulated lengths may convey at least a part of the access information of the wireless communication network. The one or more computer-executable instructions may also include an instruction to initiate a wireless transmission of the data packets of modulated lengths.

The computer-executable instructions may also include an instruction to receive the at least a part of the access information of the wireless communication network, perhaps via a character-based user interface of the wireless device or perhaps from the wireless communication network from the wireless communication network.

The computer-executable instructions may also include an instruction to direct the wireless transmission of the data packets of modulated lengths to a predetermined address of the wireless communication network. For some configurations, the at least a part of the access information may include at least one of a service set identifier (SSID), a network security protocol type, or a key value.

The computer-executable instructions may include an instruction to maintain the transmission of the data packets of modulated lengths for a predetermined amount of time. Also in some configurations, the computer-executable may include an instruction to receive an indication from the wireless communication network, where the indication may indicate that at least one other device accessed the wireless communication network. The computer-executable instructions may also include an instruction to determine if the indication was received after the transmission of the data packets of modulated lengths was initiated. Also, the computer-executable instructions may also include an instruction to initiate a termination of the transmission of the data packets of modulated lengths upon the determination that the indication was received after the transmission of the data packets of modulated lengths was initiated. In some configurations, the at least one other device may be a load control device.

In some configurations, the computer-executable instructions may include an instruction to receive a wireless signal from at least one other device, the wireless signal indicating that the at least one other device used the data packets of modulated lengths to access the wireless communication network. The computer-executable instructions may also include an instruction to determine if the signal was received after the transmission of the data packets of modulated lengths was initiated. Also, the computer-executable instructions may also include an instruction to initiate a termination of the transmission of the data packets of modulated lengths upon the determination that the signal was received after the transmission of the data packets of modulated lengths was initiated. In some configurations, the at least one other device may be a load control device.

The computer-executable instructions may include an instruction to receive a command to initiate the generation of the data packets of modulated lengths via a character-based user interface of the wireless device. In some configurations, the character-based user interface may be at least one of a touch-screen interface, a hard-key interface, or a combination touch-screen and hard-key interface. At 13008, the provided configuration, perhaps a specific provided configuration selected by a user of the one or more configurations, may be transferred to a user's wireless communication device.

Although features and elements of the various devices and techniques are described above in particular combinations, one of ordinary skill in the art will appreciate that one or more, or each, feature or element can be used alone or in any combination with the other features and elements. In addition, the methods and techniques, or parts thereof, described herein may be implemented in a computer program (e.g. computer-executable instructions), software, or firmware incorporated in a tangible computer-readable medium for execution by a computer, controller, or other processor device. Examples of computer-readable media include but are not limited to computer-readable storage media. Examples of computer-readable storage media include, but are not limited to, a read only memory (ROM), a random access memory (RAM), solid state memory, E-EPROM, EPROM, flash memory, a register, cache memory, semiconductor memory devices, magnetic media such as internal hard disks and removable disks, magneto-optical media, and optical media such as CD-ROM disks, and digital versatile disks (DVDs). Such computer-executable (or processor-executable) instructions may be executed by a processor or controller within the dimmer switch 7006 and/or the wireless control device 322, for example.

1. A system configured to communicate on a wireless communication network, comprising:
a first device configured to communicate on the wireless communication network, the first device comprising a wireless transmitter configured to communicate in at least one of a first mode or a second mode, the wireless transmitter being further configured to:
transmit data packets via a predetermined protocol in the first mode; and
transmit data packets of modulated lengths in the second mode via a wireless signal directed to a predetermined address of the wireless communication network, the modulated lengths conveying access information of the wireless communication network; and
a second device configured to communicate with a wireless communication network, the second device comprising:
a wireless receiver configured to receive the wireless signal directed to the predetermined address of the wireless communication network; and
a processor configured to determine the access information for the wireless communication network from the modulated lengths.

2. The system of claim 1, wherein the processor is a second processor and the first device further comprises a first processor configured to:
respectively modulate a length of data packets to generate the data packets of modulated lengths; and
initiate the transmission of the data packets of modulated lengths via the wireless transmitter.

3. The system of claim 2, wherein the first device further comprises a character-based user interface, and the first processor is further configured to receive the access information of the wireless communication network via the character-based user interface.

4. The system of claim 3, wherein the second device is a load control device.

5. The system of claim 3, wherein the character-based user interface is at least one of a hard-key alpha-numeric keyboard or a virtual alpha-numeric keyboard.

6. The system of claim 3, wherein the character-based user interface is at least one of a “QWERTY” hard-key keyboard or a virtual “QWERTY” keyboard.

7. The system of claim 1, wherein the wireless receiver is further configured to receive the access information of the wireless communication network from the wireless communication network.

8. The system of claim 1, wherein the access information includes at least one of a service set identifier (SSID), a network security protocol type, or a key value.

9. The system of claim 1, wherein the wireless transmitter is further configured to maintain the transmission of the data packets of modulated lengths for a predetermined amount of time.

10. The system of claim 1, wherein the wireless receiver is further configured to:
receive an indication from the wireless communication network, the indication indicating that the second device accessed the wireless communication network, and wherein the processor is a second processor and the first device further comprises a first processor configured to:
determine if the indication was received after the transmission of the data packets of modulated lengths was initiated; and
initiate a termination of the transmission of the data packets of modulated lengths upon the determination that the indication was received after the transmission of the data packets of modulated lengths was initiated.

11. The system of claim 1, wherein the processor is further configured to:
initiate access to the wireless communication network using the access information for the wireless communication network determined from the modulated lengths.

12. The system of claim 1, wherein the processor is further configured to operate in one or more modes of operation, the one or more modes of operation including a third mode.

13. The system of claim 12, further comprising a user interface, the user interface in communication with the processor, wherein the processor is further configured to receive a command via the user interface to operate in at least one mode of operation of the one or more modes of operation.

14. The system of claim 12, wherein the wireless receiver is further configured to receive the wireless signal directed to the predetermined address upon receiving an indication from the processor that the processor has been placed into the third mode.

15. The system of claim 14, wherein the third mode is an associate mode.

16. The system of claim 1, wherein the data packets of modulated lengths have respective lengths and the processor is further configured to determine the access information for the wireless communication network from the modulated lengths by decoding the respective lengths.

17. The system of claim 1, wherein the first device further comprises a character-based user interface configured such that at least one of a generation of the data packets of modulated lengths or a transmission of the data packets of modulated lengths can be initiated via the character-based user interface.

18. The system of claim 17, wherein the character-based user interface is at least one of a touch-screen interface, a hard-key interface, or a combination touch-screen and hard-key interface.

19. A device configured to communicate on a wireless communication network, the device comprising:
a processor configured to transmit data packets according to a predetermined protocol in the wireless communication network, the processor further configured to respectively modulate lengths of the data packets to generate data packets of modulated lengths, the modulated lengths conveying access information of the wireless communication network.

20. The device of claim 19, further comprising a wireless transmitter, wherein the processor is further configured to:
operate in at least one of a first mode or a second mode;
initiate a transmission of data packets via a predetermined protocol in the first mode via the wireless transmitter; and
initiate a transmission of the data packets of modulated lengths in the second mode via the wireless transmitter.

21. The device of claim 19, further comprising a character-based user interface, wherein the processor is further configured to receive the access information of the wireless communication network via the character-based interface.

22. The device of claim 20, wherein the transmission is directed to a predetermined address of the wireless communication network.

23. The device of claim 21, wherein the character-based user interface is at least one of a hard-key alpha-numeric keyboard or a virtual alpha-numeric keyboard.

24. The device of claim 21, wherein the character-based user interface is at least one of a “QWERTY” hard-key keyboard or a virtual “QWERTY” keyboard.

25. The device of claim 19, wherein the processor is further configured to receive the access information of the wireless communication network from the wireless communication network.

26. The device of claim 19, wherein the access information includes at least one of a service set identifier (SSID), a network security protocol type, or a key value.

27. The device of claim 20, wherein the processor is further configured to maintain the transmission of the data packets of modulated lengths via the wireless transmitter for a predetermined amount of time.

28. The device of claim 20, further comprising a wireless receiver, wherein the device is a first device and the processor is further configured to:
receive an indication from the wireless communication network via the wireless receiver, the indication indicating that at least one second device accessed the wireless communication network;
determine if the indication was received after the transmission of the data packets of modulated lengths was initiated; and
initiate a termination of the transmission of the data packets of modulated lengths upon the determination that the indication was received after the transmission of the data packets of modulated lengths was initiated.

29. The device of claim 28, wherein the at least one second device is a load control device.

30. The device of claim 20, further comprising a wireless receiver, wherein the device is a first device and the processor is further configured to:
receive a wireless signal from a second device via the wireless receiver, the wireless signal indicating that the second device used the data packets of modulated lengths to access the wireless communication network,
determine if the signal was received after the transmission of the data packets of modulated lengths was initiated; and
initiate a termination of the transmission of the data packets of modulated lengths upon the determination that the signal was received after the transmission of the data packets of modulated lengths was initiated.

31. The device of claim 30, wherein the second device is a load control device.

32. The device of claim 19, further comprising a character-based user interface configured such that at least one of a generation of the data packets of modulated lengths or a transmission of the data packets of modulated lengths can be initiated via the character-based user interface.

33. The device of claim 32, wherein the character-based user interface is at least one of a touch-screen interface, a hard-key interface, or a combination touch-screen and hard-key interface.

34. A device configured to communicate on a wireless communication network, the device comprising:
a wireless transmitter configured to:
operate in at least one of a first mode or a second mode;
transmit data packets via a predetermined protocol in the first mode via the wireless transmitter; and
transmit data packets of modulated lengths in the second mode, the modulated lengths conveying access information of the wireless communication network.

35. The device of claim 34, further comprising a processor configured to:
respectively modulate a length of the data packets to generate the data packets of modulated lengths; and
initiate the transmission of the data packets of modulated lengths via the wireless transmitter.

36. The device of claim 35, further comprising a character-based user interface, wherein the processor is further configured to receive the access information of the wireless communication network via the character-based user interface.

37. The device of claim 34, wherein the transmission is directed to a predetermined address of the wireless communication network.

38. The device of claim 36, wherein the character-based user interface is at least one of a hard-key alpha-numeric keyboard or a virtual alpha-numeric keyboard.

39. The device of claim 36, wherein the character-based user interface is at least one of a “QWERTY” hard-key keyboard or a virtual “QWERTY” keyboard.

40. The device of claim 34, further comprising a wireless receiver configured to receive the access information of the wireless communication network from the wireless communication network.

41. The device of claim 34, wherein the access information includes at least one of a service set identifier (SSID), a network security protocol type, or a key value.

42. The device of claim 34, wherein the wireless transmitter is further configured to maintain the transmission of the data packets of modulated lengths for a predetermined amount of time.

43. The device of claim 34, further comprising a wireless receiver, wherein the device is a first device and the wireless receiver is configured to:
receive an indication from the wireless communication network, the indication indicating that a second device accessed the wireless communication network, the first device further comprising a processor configured to:
determine if the indication was received after the transmission of the data packets of modulated lengths was initiated; and
initiate a termination of the transmission of the data packets of modulated lengths upon the determination that the indication was received after the transmission of the data packets of modulated lengths was initiated.

44. The device of claim 43, wherein the second device is a load control device.

45. The device of claim 34, further comprising a wireless receiver, wherein the device is a first device and the wireless receiver is configured to:
receive a wireless signal from a second device, the wireless signal indicating that the second device used the data packets of modulated lengths to access the wireless communication network, the first device further comprising a processor configured to:
determine if the signal was received after the transmission of the data packets of modulated lengths was initiated; and
initiate a termination of the transmission of the data packets of modulated lengths upon the determination that the signal was received after the transmission of the data packets of modulated lengths was initiated.

46. The device of claim 45, wherein the second device is a load control device.

47. The device of claim 34, further comprising a character-based user interface configured such that at least one of a generation of the data packets of modulated lengths or the transmission of the data packets of modulated lengths can be initiated via the character-based user interface.

48. The device of claim 47, wherein the character-based user interface is at least one of a touch-screen interface, a hard-key interface, or a combination touch-screen and hard-key interface.

49. A device configured to communicate with a wireless communication network, the device comprising:
a wireless receiver configured to receive a wireless signal directed to a predetermined address of the wireless communication network, the wireless signal including data packets of modulated lengths, the modulated lengths conveying access information of the wireless communication network; and
a processor configured to determine the access information for the wireless communication network from the modulated lengths.

50. The device of claim 49, wherein the device is one of a load control device, a dimmer switch, a gateway device, a remote control device, and a sensor device.

51. The device of claim 49, wherein the processor is further configured to:
initiate access to the wireless communication network using the access information for the wireless communication network determined from the modulated lengths.

52. The device of claim 51, wherein the processor is further configured to determine that access to the wireless communication network has been obtained.

53. The device of claim 52, further comprising a wireless transmitter, wherein the processor is further configured to send a signal via the wireless transmitter indicating the device accessed the wireless communication network using the access information for the wireless communication network determined from the modulated lengths.

54. The device of claim 49, wherein the processor is further configured to operate in one or more modes of operation, the one or more modes of operation including a first mode.

55. The device of claim 54, further comprising a user interface, the user interface in communication with the processor, wherein the processor is further configured to receive a command via the user interface to operate in a mode of operation of the one or more modes of operation.

56. The device of claim 54, wherein the wireless receiver is further configured to receive the wireless signal directed to the predetermined address upon receiving an indication from the processor that the processor has been placed into the first mode.

57. The device of claim 56, wherein the first mode is an associate mode.

58. The device of claim 49, wherein the data packets of modulated lengths have respective lengths and the processor is further configured to determine the access information for the wireless communication network from the modulated lengths by decoding the respective lengths.

59. A method for providing a configuration for obtaining access information for a wireless communication network, the method comprising:
providing the configuration, the configuration transferable to a tangible storage medium of a wireless device, the configuration including computer-executable instructions, and the computer-executable instructions causing a processor of the wireless device that executes the computer-executable instructions to perform one or more of the computer-executable instructions, the one or more computer-executable instructions including:
respectively modulate a length of data packets to generate data packets of modulated lengths, the modulated lengths conveying the access information of the wireless communication network; and
initiate a wireless transmission of the data packets of modulated lengths.

60. The method of claim 59, wherein the computer-executable instructions further include:
receive the access information of the wireless communication network via a character-based user interface of the wireless device.

61. The method of claim 59, wherein the computer-executable instructions further include:
receive the access information of the wireless communication network from the wireless communication network.

62. The method of claim 59, wherein the computer-executable instructions further include:
direct the wireless transmission of the data packets of modulated lengths to a predetermined address of the wireless communication network.

63. The method of claim 59, wherein the access information includes at least one of a service set identifier (SSID), a network security protocol type, or a key value.

64. The method of claim 59, wherein the computer-executable instructions further include:
maintain the transmission of the data packets of modulated lengths for a predetermined amount of time.

65. The method of claim 59, wherein the computer-executable instructions further include:
receive an indication from the wireless communication network, the indication indicating that another device accessed the wireless communication network;
determine if the indication was received after the transmission of the data packets of modulated lengths was initiated; and
initiate a termination of the transmission of the data packets of modulated lengths upon the determination that the indication was received after the transmission of the data packets of modulated lengths was initiated.

66. The method of claim 65, wherein the other device is a load control device.

67. The method of claim 59, wherein the computer-executable instructions further include:
receive a wireless signal from another device, the wireless signal indicating that the other device used the data packets of modulated lengths to access the wireless communication network;
determine if the signal was received after the transmission of the data packets of modulated lengths was initiated; and
initiate a termination of the transmission of the data packets of modulated lengths upon the determination that the signal was received after the transmission of the data packets of modulated lengths was initiated.

68. The method of claim 67, wherein the other device is a load control device.

69. The method of claim 59, wherein the computer-executable instructions further include:
receive a command to initiate the generation of the data packets of modulated lengths via a character-based user interface of the wireless device.

70. The method of claim 69, wherein the character-based user interface is at least one of a touch-screen interface, a hard-key interface, or a combination touch-screen and hard-key interface.
